(19) United States
(12) Patent Application Publication
(10) Pub. No.: US 2007/0061499 A1
(43) Pub. Date: Mar. 15, 2007

(54) Methods and apparatus for providing a virtual flash device

(76) Inventor: John C. Rudelic, Folsom, CA (US)

Correspondence Address: INTEL CORPORATION;C/O INTELLEVATE, LLC, P.O. BOX 52050, MINNEAPOLIS, MN, 55402, US

(21) Appl. No.: 11/223,156

(22) Filed: Sep. 9, 2005

(51) Int. Cl. G06F 12/00

(52) U.S. Cl. 711/103; 711/170

(57) ABSTRACT

Embodiments of methods and apparatus for providing a virtual flash device are generally described herein. Other embodiments may be described and claimed.

### TECHNICAL FIELD

The present disclosure relates generally to flash memory systems, and more particularly, to methods and apparatus for providing a virtual flash device.

### BACKGROUND

Typically, a flash memory may be well suited for wireless electronic devices such as cellular telephones because a flash memory may retain digital information without power. In particular, a flash memory (e.g., a flash random access memory (RAM)) is a non-volatile memory that may be erased or written in units of blocks. In one example, a flash memory may store control code such as basic input/output system (BIOS) of a processor. Instead of erasing or writing at a byte level such as an electrically erasable programmable read-only memory (EEPROM), a flash memory may update or change the BIOS faster by erasing or writing in block sizes.

### BRIEF DESCRIPTION OF THE DRAWINGS

FIG. 1 is a schematic diagram representation of an example flash memory system according to an embodiment of the methods and apparatus disclosed herein.

FIG. 2 is a block diagram representation of an example flash array having a first flash configuration.

FIG. 3 is a block diagram representation of an example flash array having a second flash configuration.

FIG. 4 is a block diagram representation of an example virtualized flash array.

FIG. 5 is a flow diagram representation of one manner to provide a virtual flash device.

FIG. 6 is a block diagram representation of an example processor system that may be used to implement an example flash memory system of FIG. 1.

### DETAILED DESCRIPTION

In general, methods and apparatus for providing a virtual flash device are described herein. The methods and apparatus described herein are not limited in this regard.

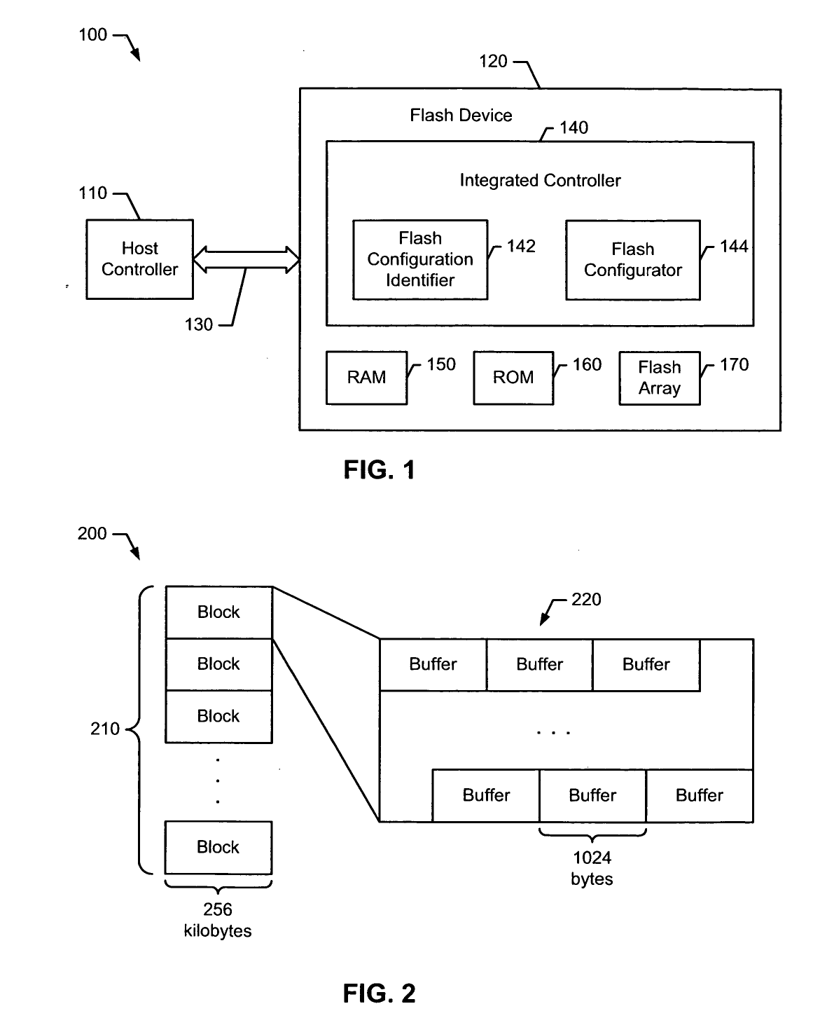

Referring to FIG. 1, an example flash memory system 100 may include a host controller 110 and a flash device 120. In general, the flash memory system 100 may be implemented in an electronic device (not shown). For example, the flash memory system 100 may be implemented in a desktop computer, a network server, a laptop computer, a handheld computer, a tablet computer, a cellular telephone (e.g., a smart phone), a pager, an audio and/or video player (e.g., an MP3 player or a DVD player), a gaming device, a digital camera, a navigation device (e.g., a global position system (GPS) device), a medical device (e.g., a heart rate monitor, a blood pressure monitor, etc.), and/or other suitable relatively stationary, mobile, and/or portable electronic devices.

The host controller 110 (e.g., a processor) may be operatively coupled to the flash device 120 via a flash interface 130. In general, the host controller 110 may be configured to communicate with the flash device 120 via the flash interface 130. For example, the flash interface 130 may include a bus, and/or a direct link between the host controller 110 and the flash device 120.

The flash device 120 may include an integrated controller 140, a random access memory (RAM) 150, a read only memory (ROM) 160, and a flash array 170. In addition or alternatively, the flash device 120 may include other volatile memory and/or non-volatile memory. The integrated controller 140, the RAM 150, the ROM 160, and/or the flash array 170 may be operatively coupled to each other via a bus and/or a direct link.

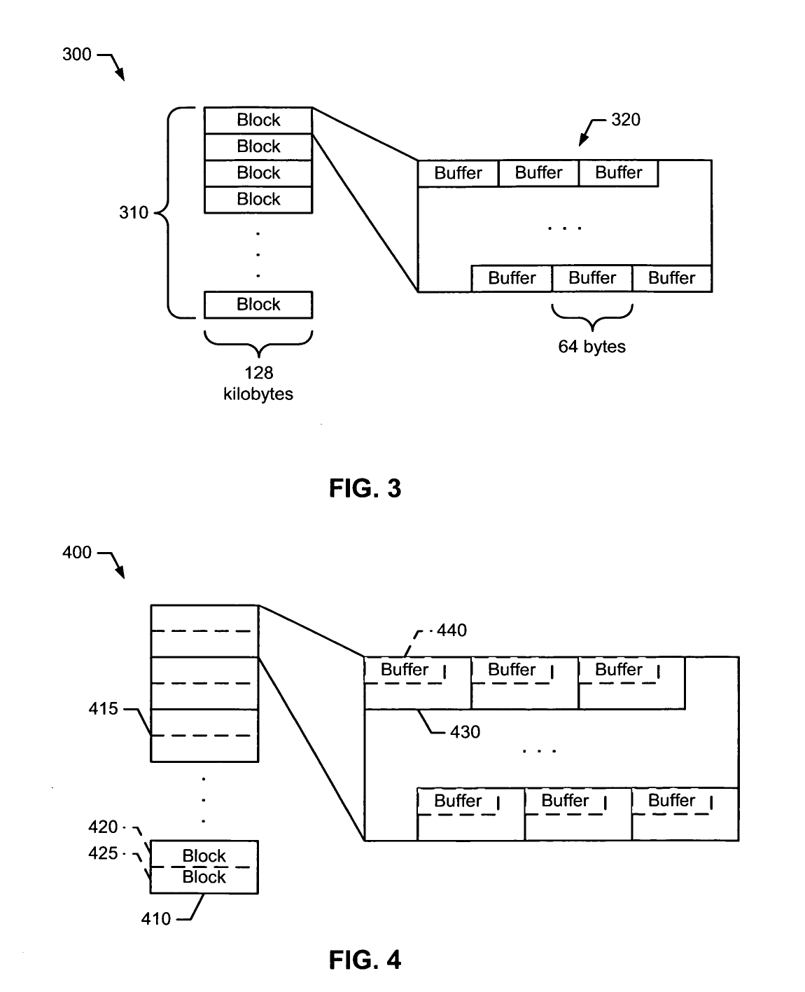

In general, the integrated controller 140 may provide virtual resources to the host controller 110 based on physical resources of the flash array 170. The integrated controller 140 may include a flash configuration identifier 142 and a flash configurator 144. As described in detail below, the flash configuration identifier 142 may be configured to identify a first flash configuration of the flash array 170 (e.g., the flash configuration 200 in FIG. 2). For example, the first flash configuration may be a physical flash configuration or a default flash configuration of the flash array 170. The flash configuration identifier 142 may also identify a second flash configuration (e.g., the flash configuration 300 of FIG. 3). For example, the second flash configuration may be a logical flash configuration or an alternate flash configuration.

In general, the flash configurator 144 may be configured to configure the flash array 170 from the first flash configuration to the second flash configuration. Although the flash array 170 may be physically configured to operate in accordance with the first flash configuration, the flash array 170 may be logically configured to operate in accordance with the second flash configuration with respect to the flash memory system 100. In one example, the flash configurator 144 may configure the flash array 170 from a physical flash configuration to a logical flash configuration with respect to the host controller 110.

The RAM 150 may be a storage in which content may be accessed (e.g., written to and/or read from) in various order (e.g., random). The ROM 160 may be a storage in which content may only be read from. For example, the ROM 160 may store firmware.

As described in detail below, a data partition and/or a code partition of the flash array 170 may be reconfigured by the integrated controller 140 to operate in accordance with one or more flash configurations. Although the flash array 170 may be configured to operate in accordance with a physical flash configuration, the methods and apparatus described herein may configure the flash array 170 to operate in accordance with a logical flash configuration with respect to the host controller 110. That is, the flash array 170 may appear to the host controller 110 as operating in accordance with the logical flash configuration. Thus, the flash device 120 may be compatible to interface with host controller(s) (e.g., the host controller 110) via a variety of sockets.

While the components shown in FIG. 1 are depicted as separate blocks within the flash device 120, the functions performed by some of these blocks may be integrated within a single semiconductor circuit or may be implemented using two or more separate integrated circuits. For example, although the flash configuration identifier 142 and the flash configurator 144 are depicted as separate blocks within the flash device 120, the flash configuration identifier 142 may be integrated into the flash configurator 144 or vice versa. The methods and apparatus described herein are not limited in this regard.

In the example of FIG. 2, the flash array 170 may be configured to operate in accordance with a first flash configuration 200. In one example, the first flash configuration 200 may include a plurality 256-kilobyte (kB) blocks, generally shown as 210. Each of the plurality of 256-kB blocks 210 may include a plurality of 1024-byte program buffers, generally shown as 220. The first flash configuration 200 may include an operation restriction (e.g., a program restriction). In one example, the first flash configuration 200 may include a two-row write restriction. Although the above example describes an operation restriction, the first flash configuration 200 may not include a program restriction. The methods and apparatus described herein are not limited in this regard.

Turning to FIG. 3, for example, the flash array 170 may be configured to operate in accordance with a second flash configuration 300. In one example, the second flash configuration 300 may include a plurality of 128-kB blocks, generally shown as 310. Each of the plurality of 128-kB blocks 310 may include a plurality of 64-byte program buffers, generally shown as 320. In contrast to the first flash configuration 200, the second flash configuration 300 may not include operation restrictions. The methods and apparatus described herein are not limited in this regard.

To provide backward compatibility and/or compatibility host controllers via a variety of sockets, the integrated controller 140 may virtualize the flash array 170 with respect to the flash memory system 100. That is, the flash array 170 may initially be configured to operate in accordance with one flash configuration but the integrated controller 140 may virtualize the flash array 170 so that the flash array 170 may appear to the flash memory system 100 as if the flash array 170 is configured to operate in accordance with another flash configuration. In one example, the flash array 170 may be physically configured to operate in accordance with one flash configuration but the integrated controller 140 may logically reconfigure the flash array 170 to operate in accordance with another flash configuration. In another example, the flash array 170 may be pre-configured to operate in accordance with a default flash configuration but the integrated controller 140 may configure the flash array 170 to operate in accordance with one or more alternate flash configurations.

In the example of FIG. 4, the flash array 170 may initially be configured to operate in accordance with the first flash configuration 200 (FIG. 2) but the integrated controller 140 may configure the flash array 170 to operate in accordance with the second flash configuration 300 (FIG. 3) with respect to the host controller 110. As described above, one block associated with the first flash configuration 200 (e.g., a physical block) may emulate two blocks associated with the second flash configuration 300 (e.g., two logical blocks). In one example, the physical block 410 may be a 256-kB block, which may be configured to operate as two 128-kB logical blocks, generally shown as 420 and 425. Further, one program buffer associated with the first flash configuration 200 (e.g., a physical program buffer) may emulate a plurality of program buffers associated with the second flash configuration 300 (e.g., a plurality of logical program buffers). In one example, a program buffer 430 may be a 1024-byte program buffer, which may be configured to operate as sixteen 64-byte program buffers, generally shown as 440. Thus, the flash array 170 may be physically configured to operate in accordance with the first flash configuration 200 but the integrated controller 140 may configure the flash array 170 to provide virtual resources associated with the second flash configuration 300.

To perform a program operation (e.g., a write operation), for example, the integrated controller 140 may read 64 bytes of data from the physical program buffer 430. Although the physical program buffer 430 may be physically configured to include 1024 bytes of data, the physical program buffer 430 may appear as the logical program buffer 440 with respect to the host controller 110. As noted above, each of the plurality of logical program buffers 440 may store 64 bytes of data.

Initially, the physical program buffer 430 may be empty (i.e., no existing data). In one example, the integrated controller 140 may not detect any data during the first execution of a program operation because the physical program buffer 430 may not be storing any data. As noted above, the first flash configuration 200 may be associated with a two-row write restriction. Accordingly, the integrated controller 140 may write 64 new bytes of data into a two-row sector of the physical program buffer 430. Although the above example describes a program restriction, the methods and apparatus described herein may implemented with flash configurations without operation restrictions.

The integrated controller 140 may update physical/logical sector information of the flash array 170. In one example, the physical/logical sector information may include a physical layer (PHY) address with the flash array 170. In addition or alternatively, the integrated controller 140 may store the physical/logical sector information in a sector table including one or more sector identifiers to locate data stored in the physical program buffer 430. For example, a sector identifier may be a numeric identifier, an alphanumeric identifier, and/or any other suitable identifier.

Otherwise if the physical program buffer 430 includes existing data, the integrated controller 140 may copy the data from the two-row sector of the physical program buffer 430 to the RAM 150. The integrated controller 140 may add 64 new bytes of data into the RAM 150. For example, the integrated controller 140 may concatenate the copied data from the two-row sector of the physical program buffer 430 with the 64 new bytes of data. The integrated controller 140 may configure the new data in the RAM 150 to operate in accordance with the first flash configuration 200. To clear all data from the physical program buffer 430, the integrated controller 140 may invalidate the two-row sector of the physical program buffer 430. Accordingly, the integrated controller 140 may update physical/logical sector information corresponding to the program operation.

To perform an erase operation, for example, the integrated controller 140 may copy data from a first physical block (e.g., the physical block 410) to a second physical block (e.g., the physical block 415). In one example, the first physical block 410 may include data of the first and second logical blocks 420 and 425. To erase data of the first logical block 420, for example, the integrated controller 140 may copy data of the second logical block 425 to the second physical block 415 to preserve the data of the second logical block 425. To clear the first physical block 410, the integrated controller 140 may erase the data of the first physical block 410. As a result, the integrated controller 140 may erase the data of the first and second logical blocks 420 and 425 from the first physical block 410. The integrated controller 140 may copy the data of the second physical block 415 (i.e., the data of the second physical block 425) back to the first physical block 410. Thus, the first physical block 410 may include the data of the second logical block 425 but not the data of the first logical block 420. Accordingly, the integrated controller 140 may update the physical/logical sector information of the flash array 170.

To erase the data of the second logical block 425 instead of the data of the first logical block 420, for example, the integrated controller 140 may operate in a similar manner. In particular, the integrated controller 140 may copy the data of the first logical block 420 to the second physical block 415, and erase the data of the first physical block 410. As a result, the integrated controller 140 may erase the data of the first and second logical blocks 420 and 425 from the first physical block 410. The integrated controller 140 may copy the data of the second physical block 415 (i.e., the data of the first logical block 420) back to the first physical block 410. Thus, the first physical block 410 may include the data of the first logical block 420 but not the data of the second logical block 425. Accordingly, the integrated controller 140 may update the physical/logical sector information of the flash array 170.

Although the above example describes configuring the flash array 170 from a physical flash configuration to a logical flash configuration, the integrated controller 140 may configure the flash array 170 from a default flash configuration to an alternate flash configuration. Also, while FIGS. 2, 3, and 4 depict two flash configurations, the flash array 170 may be configured to operate in accordance with additional flash configurations. Further, although the above examples described in connection with FIGS. 2, 3, and 4 depict particular flash configurations, the flash array 170 may be configured to operate in accordance with other flash configurations. For example, the flash array 170 may be configured to operate in accordance with flash configurations with other suitable block sizes, program buffer sizes, and/or operation restrictions. The methods and apparatus described herein are not limited in this regard.

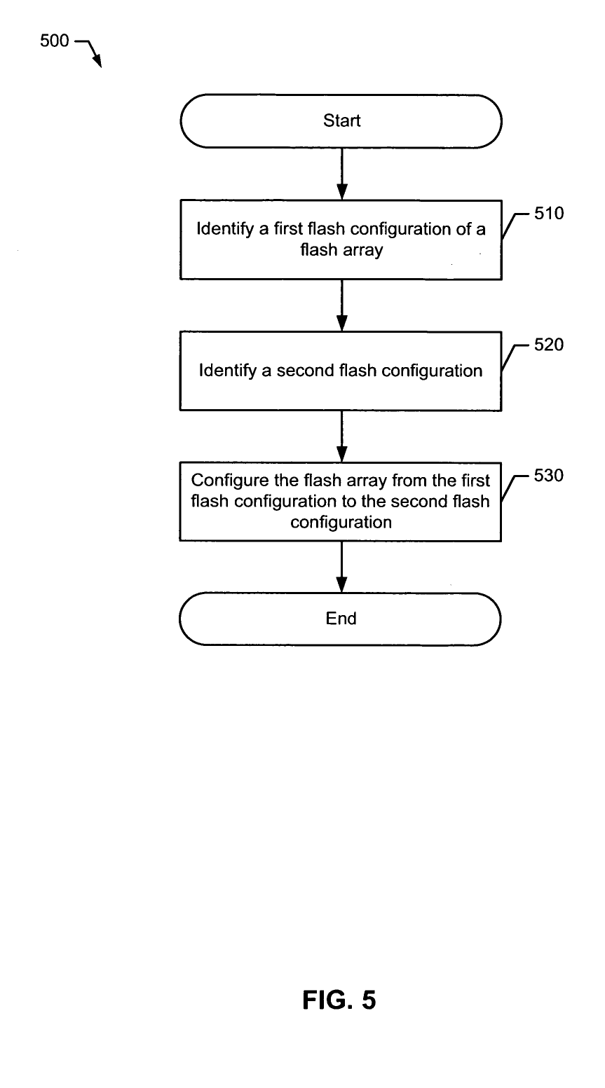

FIG. 5 depicts one manner in which the example flash device 120 of FIG. 1 may be virtualized. The example process 500 of FIG. 5 may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a ROM, a RAM, a magnetic media, an optical media, and/or any other suitable type of medium.

Further, although a particular order of actions is illustrated in FIG. 5, these actions may be performed in other temporal sequences. For example, the actions illustrated in FIG. 5 may be executed repetitive, serial, and/or parallel manners. Again, the example process 500 is merely provided and described in conjunction with the apparatus and configurations of FIGS. 1, 2, 3, and 4 as an example of one way to virtualize a flash device.

In the example of FIG. 5, the process 500 may begin with the integrated controller 140 of the flash device 120 (e.g., via the flash configuration identifier 142) identifying a first flash configuration of the flash array 170 (block 510). In one example, the flash array 170 may be operating in accordance with the first flash configuration 200 (FIG. 2). As noted above, for example, the first flash configuration 200 may be a physical flash configuration associated with a 256-kB block size, a 1024-byte program buffer size, and a two-row write restriction.

The integrated controller 140 may identify a second flash configuration (block 520). The second flash configuration may be selected by a user. In one example, the integrated controller 140 may identify the second flash configuration 300 (FIG. 3) in response to receipt of a user input associated with a common flash interface (CFI) identifier. The CFI identifier may correspond and indicate the second flash configuration 300. As noted above, for example, the second flash configuration 300 may be a logical flash configuration associated with a 128-kB block size, and a 64-byte program buffer size.

Accordingly, the integrated controller 140 may configure the flash array 170 from the first flash configuration to the second flash configuration (block 530). For example, the integrated controller 140 may reconfigure a data partition and/or a code partition of the flash array 170. Although the flash array 170 may be configured to operate in accordance with a physical flash configuration, the integrated controller 140 may configure the flash array 170 to operate in accordance with a logical flash configuration. Thus, the flash array 170 may provide the logical flash configuration to the host controller 110 via the flash interface 130. The methods and apparatus described herein are not limited in this regard.

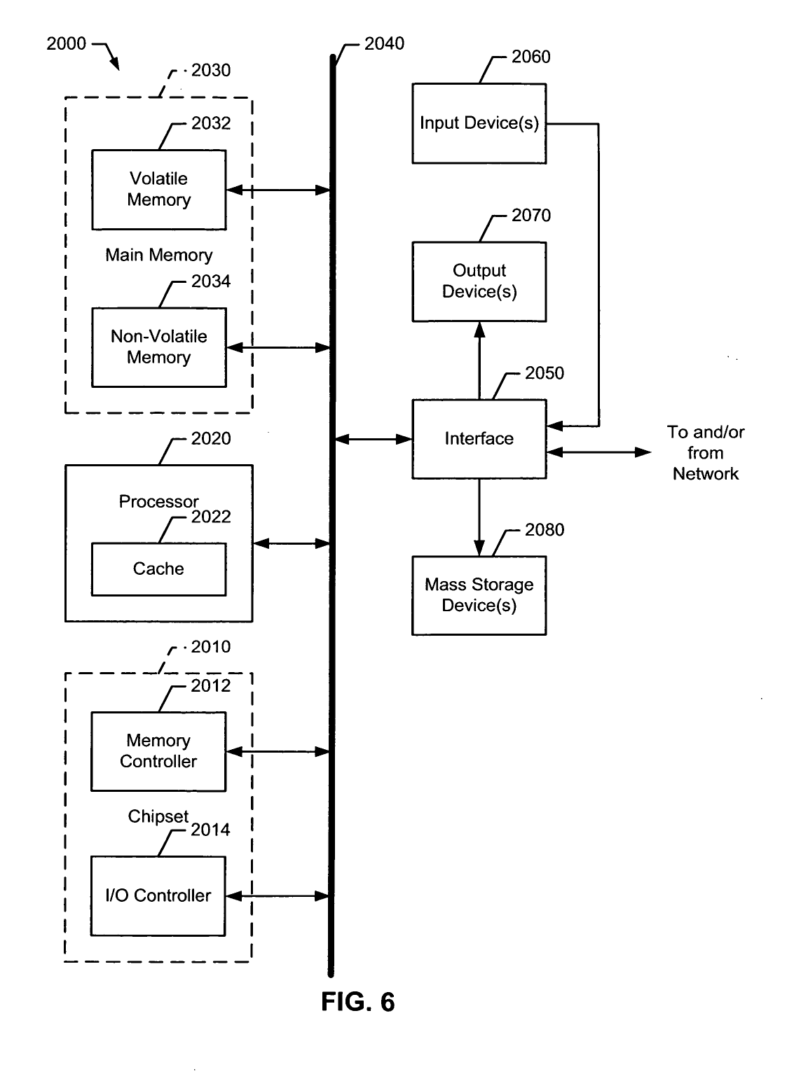

FIG. 6 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 6 includes a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WLAN components, WMAN components, WWAN components, and/or other suitable processing components. For example, the processor 2020 may be implemented using one or more of the Intel® Pentium® technology, the Intel® Itanium® technology, the Intel® Centrino™ technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output interface (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 6 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
identifying a first flash configuration of a reconfigurable flash array integrated with a controller;
identifying a second flash configuration; and
configuring the reconfigurable flash array from the first flash configuration to the second flash configuration.

2. A method as defined in claim 1, wherein identifying the first flash configuration comprises identifying a physical flash configuration having one or more characteristics different than one or more characteristics of the second flash configuration, and wherein the one or more characteristics include at least one of a block size, a program buffer size, or an operation restriction.

3. A method as defined in claim 1, wherein identifying the first flash configuration comprises identifying a physical flash configuration associated with a 256-kilobyte block size, a 1024-byte program buffer size, and a two-row write restriction.

4. A method as defined in claim 1, wherein identifying the second flash configuration comprises identifying a logical flash configuration in response to receipt of a user input associated with a common flash interface identifier.

5. A method as defined in claim 1, wherein identifying the second flash configuration comprises identifying a logical flash configuration having one or more characteristics different than one or more characteristics of the first flash configuration, and wherein the one or more characteristics include at least one of a block size, a program buffer size, or an operation restriction.

6. A method as defined in claim 1, wherein identifying the second configuration comprises identifying a logical flash configuration associated with a 128-kilobyte block size, and a 64-byte program buffer size.

7. A method as defined in claim 1, wherein configuring the reconfigurable flash array comprises configuring the reconfigurable flash array from a physical flash configuration to a logical flash configuration to execute at least one of a program operation or an erase operation.

8. A method as defined in claim 1, wherein configuring the reconfigurable flash array comprises configuring at least one of a data partition or a code partition of the reconfigurable flash array from the first flash configuration to the second flash configuration.

9. An article of manufacture including content, which when accessed, causes a machine to:
identify a first flash configuration of a reconfigurable flash array integrated with a controller;
identify a second flash configuration; and
configure the reconfigurable flash array from the first flash configuration to the second flash configuration.

10. An article of manufacture as defined in claim 9, wherein the content, when accessed, causes the machine to identify the first flash configuration by identifying a physical flash configuration having one or more characteristics different than one or more characteristics of the second flash configuration, and wherein the one or more characteristics include at least one of a block size, a program buffer size, or an operation restriction.

11. An article of manufacture as defined in claim 9, wherein the content, when accessed, causes the machine to identify the first flash configuration by identifying a physical flash configuration associated with a 256-kilobyte block size, a 1024-byte program buffer size, and a two-row write restriction.

12. An article of manufacture as defined in claim 9, wherein the content, when accessed, causes the machine to identify the second flash configuration by identifying a logical flash configuration in response to receipt of a user input associated with a common flash interface identifier.

13. An article of manufacture as defined in claim 9, wherein the content, when accessed, causes the machine to identify the second flash configuration by identifying a logical flash configuration having one or more characteristics different than one or more characteristics of the first flash configuration, and wherein the one or more characteristics include at least one of a block size, a program buffer size, or an operation restriction.

14. An article of manufacture as defined in claim 9, wherein the content, when accessed, causes the machine to identify the second configuration by identifying a logical flash configuration associated with a 128-kilobyte block size, and a 64-byte program buffer size.

15. An article of manufacture as defined in claim 9, wherein the content, when accessed, causes the machine to configure the reconfigurable flash array by configuring the reconfigurable flash array from a physical flash configuration to a logical flash configuration to execute at least one of a program operation or an erase operation.

16. An article of manufacture as defined in claim 9, wherein the content, when accessed, causes the machine to configure the reconfigurable flash array by configuring at least one of a data partition or a code partition of the reconfigurable flash array from the first flash configuration to the second flash configuration.

17. An apparatus comprising:
a reconfigurable flash array configured to a first flash configuration; and
a controller integrated with the reconfigurable flash array to identify a second flash configuration, and to configure the reconfigurable flash array from the first flash configuration to the second flash configuration.

18. An apparatus as defined in claim 17, wherein the first flash configuration comprises a physical flash configuration having one or more characteristics different than one or more characteristics of the second flash configuration, and wherein the one or more characteristics include at least one of a block size, a program buffer size, or an operation restriction.

19. An apparatus as defined in claim 17, wherein the first flash configuration comprises a physical flash configuration associated with a 256-kilobyte block size, a 1024-byte program buffer size, and a two-row write restriction.

20. An apparatus as defined in claim 17, wherein the second flash configuration comprises a logical flash configuration having one or more characteristics different than one or more characteristics of the first flash configuration, and wherein the one or more characteristics include at least one of a block size, a program buffer size, or an operation restriction.

21. An apparatus as defined in claim 17, wherein the second flash configuration comprises a logical flash configuration associated with a 128-kilobyte block size, and a 64-byte program buffer size.

22. An apparatus as defined in claim 17, wherein the controller is configured to identify the second flash configuration in response to a user input associated with common flash interface identifier.

23. An apparatus as defined in claim 17, wherein the controller is configured to configure the reconfigurable flash array from a physical flash configuration to a logical flash configuration to execute at least one of a program operation or an erase operation.

24. An apparatus as defined in claim 17, wherein the controller is configured to configure at least one of a data partition or a code partition of the reconfigurable flash array from the first flash configuration to the second flash configuration.

25. A system comprising:
a processor; and
a flash memory operatively coupled to the processor, the flash memory having a reconfigurable flash array and an integrated controller to identify a first flash configuration of the reconfigurable flash array, to identify a second flash configuration, and to configure the reconfigurable flash array from the first flash configuration to a second flash configuration.

26. A system as defined in claim 25, wherein the integrated controller is configured to identify a physical flash configuration having one or more characteristics different than one or more characteristics of the second flash configuration, and wherein the one or more characteristics include at least one of a block size, a program buffer size, or an operation restriction.

27. A system as defined in claim 25, wherein the integrated controller is configured to identify a physical flash configuration associated with a 256 kilobyte block size, a 1024 byte program buffer size, and a two-row write restriction.

28. A system as defined in claim 25, wherein the integrated controller is configured to identify a logical flash configuration in response to receipt of a user input associated with a common flash interface identifier.

29. A system as defined in claim 25, wherein the integrated controller is configured to identify a logical flash configuration associated with a 128-kilobyte block size, and a 64-byte program buffer size.

30. A system as defined in claim 25, wherein the integrated controller is configured to configure the reconfigurable flash array from a physical flash configuration to a logical flash configuration to execute at least one of a program operation or an erase operation.
